(19) United States
(12) Patent Application Publication
(10) Pub. No.: US 2019/0098038 A1
(43) Pub. Date: Mar. 28, 2019

(54) REDUCING A POSSIBLE ATTACK ON A WEAK POINT OF A DEVICE VIA A NETWORK ACCESS POINT

(71) Applicant: SIEMENS AKTIENGESELLSCHAFT, München (DE)

(72) Inventor: RAINER FALK, POING (DE)

(21) Appl. No.: 16/087,812

(22) PCT Filed: Feb. 13, 2017
(86) PCT No.: PCT/EP2017/053107

§ 371 Date: Sep. 24, 2018

(30) Foreign Application Priority Data
Mar. 31, 2016 (DE) 10 2016 205 321.3

(51) Int. Cl. H04L 29/06

(52) U.S. Cl. CPC H04L 63/1433; H04L 63/0823; H04L 63/20

(57) ABSTRACT

A method for reducing a possible attack on a weak point of a device via a network access point to a network is proposed, wherein a configuration of the device is analysed in a first step, wherein communication via the network access point is restricted by a network access filter with the aid of a selectable filter rule in a second step if a weak point is detected on the basis of the analysed configuration, in particular a lack of up-to-dateness of the configuration, and wherein the filter rule is topologically applied between the network access point and a main function of the device. A corresponding device and a computer program product are proposed. A type of reverse network admission control principle is therefore applied.

### CROSS-REFERENCE TO RELATED APPLICATIONS

This application claims priority to PCT Application No. PCT/EP2017/053107, having a filing date of Feb. 13, 2017, based on German Application No. 10 2016 205 321.3, having a filing date of Mar. 31, 2016, the entire contents both of which are hereby incorporated by reference.

### FIELD OF TECHNOLOGY

Components or devices in industrial environments such as automation facilities or control facilities often have a long operating life. In particular components having a safety-relevant functionality, such as for example implementing an emergency stop for drive controllers in critical systems, should be protected against attacks from connected open networks, such as for example the Internet or a mobile radio network. To this end, in particular the connection to networks needs to be checked in respect of potential weak points or points of attack. In the case of detected weak points or points of attack, it is in reality often impossible to ensure repair for example of a fault in the configuration of the device in a timely manner. In particular, a configuration may be outdated and an update may be required. What is known as patching, that is to say the introduction of software updates, to repair a detected weak point is often only possible in maintenance windows that are provided for this purpose, such that a device is in an outdated configuration over a long period of time.

What is known as Network Admission Control or Trusted Network Connect is known, in which a client, upon logging on to a network, transmits information regarding the configuration thereof. A client that is not securely configured, in which for example there is no patch or a virus scanner is not up to date or active, is able to be rejected externally, that is to say from the side of a network, or to only be connected to a quarantine network. The network must provide a corresponding functionality in order to do this.

### SUMMARY

An aspect relates to a simple securing of a network connection between a device and a network.

The following relates to a method for reducing a possibility of attack on a weak point of a device via a network access point to a network,
wherein, in a first step, a configuration of the device is analyzed,
wherein, in a second step, in the event of a weak point detected on the basis of the analyzed configuration, in particular a lack of up-to-dateness of the configuration, communication via the network access point is restricted by way of a network access filter with the aid of a selectable filter policy, and wherein the filter policy is applied topologically between the network access point and a main function of the device.

A configuration of the device is for example characterized by software or a configuration that is loaded thereon, or by its firmware. The up-to-dateness of a software state, configuration state or firmware state may in particular be an indicator of a weak point that could be exploited by IT attacks, for example in order to manipulate a safety-critical functionality of a device. A presence or an up-to-dateness of a virus scanner also characterizes the configuration. The detected weak point may therefore also for example be the lack of a virus scanner.

The network is in particular an open network, such as for example the Internet or a mobile radio network. In particular, the device additionally uses the open network besides a closed company network.

To analyze the configuration of the device, an app manager or device manager is used, for example. A comparison is made between configuration properties that are provided for the device, for example, which configuration properties are able to be accessed by the device manager. If this comparison reveals that a configuration should be classified as critical or unsecure, a filter policy is selected and applied by way of a network access filter. A filter policy may in this case in particular prevent communication of sensitive data via the network access point to the open network. The transmission of data from the network, for example of control orders from the network to the device, via the network access point, may likewise be prohibited. Network-based attacks are therefore advantageously prevented. A network connection may in particular be permanently blocked. The block is then lifted for example by an administrator. Such a relatively strict policy may expediently be applied in the case of particularly critical weak points.

The filter policy may be provided in particular by the app/device manager. For example, an Internet of Things field device is provided with a filter policy adjusted thereto, depending on known weak points. If an app/device manager is not able to be reached, a standard filter policy or a filter policy provided for situations of lack of reachability may be applied.

An attack or network-based attack is understood to mean for example the reading or the manipulation of sensitive data of the device or data that are intended for the device, or in particular an attack on a security mechanism, such as for example the switching off of a security mechanism that is implemented on the device. For example, as a result of this, data transmitted from the network via the network access point would be processed on the field device without security checking, or manipulated data would be processed. In particular, an erroneously transmitted certificate would not be checked, or be checked without consequence. An attack is promising when a device has a weak point due to an erroneous or outdated configuration. For this reason, it is especially important to protect the state of a device having a weak point or to shield the device in particular against attacks in phases having an analyzed weak point.

A weak point, in the context of the present application, is understood to mean a state of the device that potentially does not withstand an attack or in which it is desired to protect the device in particular as a precautionary measure in order to reduce an area of attack. It is assumed here in particular that an attack may be unsuccessful even when a weak point is present.

A main function of the device is understood to mean the function, executed by the device in its role within a facility, that is to be protected. In particular, attacks via the network would affect the main function and cause damage to the device or a damaging interaction with other devices. A main function may be formed of several functions that the device is intended to execute within the installation. A main function may in particular be a control or monitoring function of a technical system that is acted on by actuators or whose current state is determined by sensors.

According to the method described, in the case of an unpatched system for example, a functionality, in particular the possibility of sending or receiving sensor values or control orders, is restricted. At the same time, the possibility of present and detected weak points being able to be exploited via a network is advantageously prevented. A type of reverse Network Admission Control is thus applied in principle. By way of a type of reverse Network Admission Control, a field device restricts its communication itself in the case of a weak configuration or a configuration that is suspected not to be up to date in order to reduce the area of attack. The method may advantageously be implemented on a terminal, such as for example a field device or an Internet of Things field device, without specific requirements having to be met on the network side. A simple and easily retrofittable solution for reducing network-based attacks on a field device is therefore made possible in particular for devices applied in the Internet of Things, the Industrial Internet, cyberphysical systems or the Web of Systems.

A client therefore itself detects a weak point in its own configuration and itself initiates a network access restriction by way of appropriate filter policies. The filter policy is in this case applied topologically between the main function of the device and the network access point, that is to say on the client side. The functioning of the network remains unaffected, that is to say field devices do not have to be monitored on the server side and there also does not have to be any blocking of data connections or any filtering of data.

According to one refinement, the device authenticates itself with the network, in particular via a Network Access Control method. In this case, a method according to the IEEE 802.1X standard may advantageously be performed.

According to one development, the device authenticates itself with a cloud service, in particular by way of a TLS method using a digital device certificate. The Transport Layer Security method is advantageously used, for example in order to construct a web-based secure connection.

According to one refinement, the filter policy is able to be selected from a number of several filter policies. In particular, depending on the detected weak point, various filters may be used. The scope of the restricted communication depends in particular on the severity of the detected weak point. For example, only some parts of the network connectivity are restricted if an effect of the weak point is known, and is likewise for example completely blocked if effects of a detected weak point are still unknown or are unpredictable.

According to one refinement, the network access filter activates one of the filter policies according to a fixed or changeable assignment policy. Several of the selectable filter policies may in particular be applied.

According to one refinement, depending on the selected filter policy, further security rules of the device are adjusted. For example, network services may be deactivated on the field device depending on the selected filter policy. For example, rules for a mandatory access control system, such as SELinux, SMACK or AppArmor, may be adjusted.

The following furthermore relates to an access device for protecting against an attack on a weak point of a device via a network access point to a network, comprising
a component for analyzing a configuration,
a network access filter for restricting communication via the network access point with the aid of a filter policy in the event of a weak point detected on the basis of the analyzed configuration,
wherein the network access filter is provided topologically between the network access point and a main function of the device.

The components and the network access filter may be implemented and executed in software, hardware or in a combination of software and hardware. The steps implemented by these units may thus be stored as program code on a storage medium, in particular a hard disk, CD-ROM or a storage module, wherein the individual program code instructions are read and processed by at least one computing unit comprising a processor.

According to one refinement, the network access filter of the access device is integrated into the device. According to one refinement, the component is integrated into the device. The access device may therefore advantageously be implemented on the field device.

According to one refinement, the network access filter is configured separately from the device. According to one refinement, the component is configured separately from the device. Therefore, the access device may for example be provided as a ballast component for the device. The ballast component is therefore arranged topologically between the device and the network.

According to one development, the component has a local interface or a network interface to the device or a communication interface to a virtual twin of the device.

The following relates furthermore to a computer program product (non-transitory computer readable storage medium having instructions, which when executed by a processor, perform actions) having a computer program that has means for performing the method described above when the computer program is executed on a program-controlled apparatus.

A computer program product, such as for example a computer program or computer program means, may be provided or supplied for example as a storage medium, such as for example a memory card, a USB stick, a CD-ROM, a DVD, or else in the form of a file downloadable from a server in a network. This may be carried out for example in a wireless communication network by the transmission of a corresponding file containing the computer program product or the computer program means. A program-controlled apparatus may be in particular a control apparatus, such as for example a microprocessor for a smartcard or the like.

### BRIEF DESCRIPTION

Some of the embodiments will be described in detail, with references to the following Figures, wherein like designations denote like members, wherein:

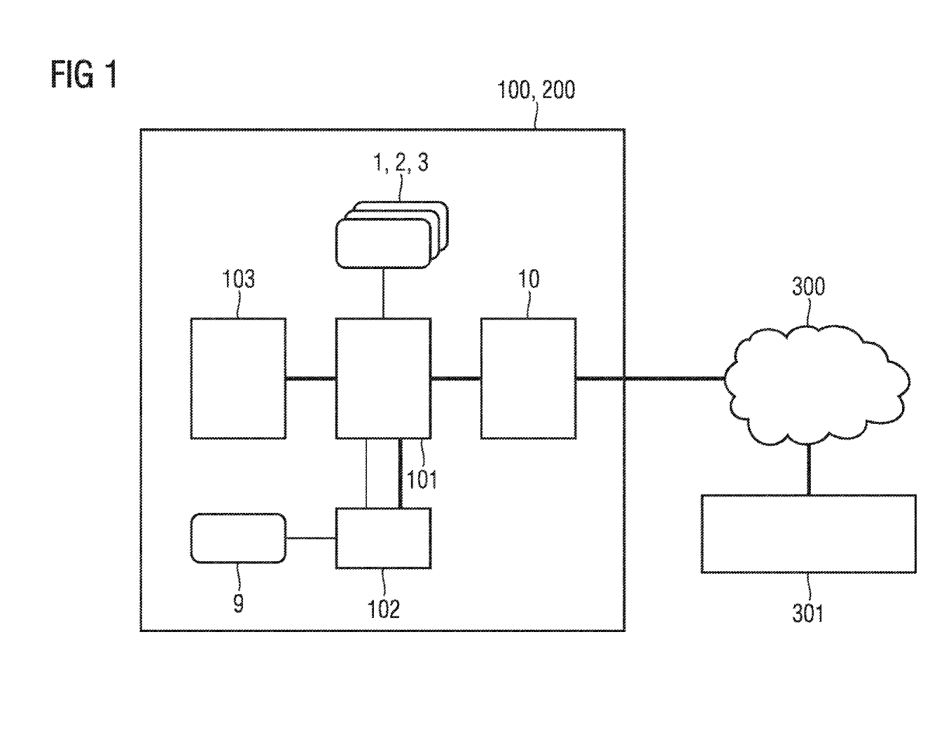

FIG. 1 shows a schematic depiction of an access device integrated into a field device, according to a first embodiment of the invention;

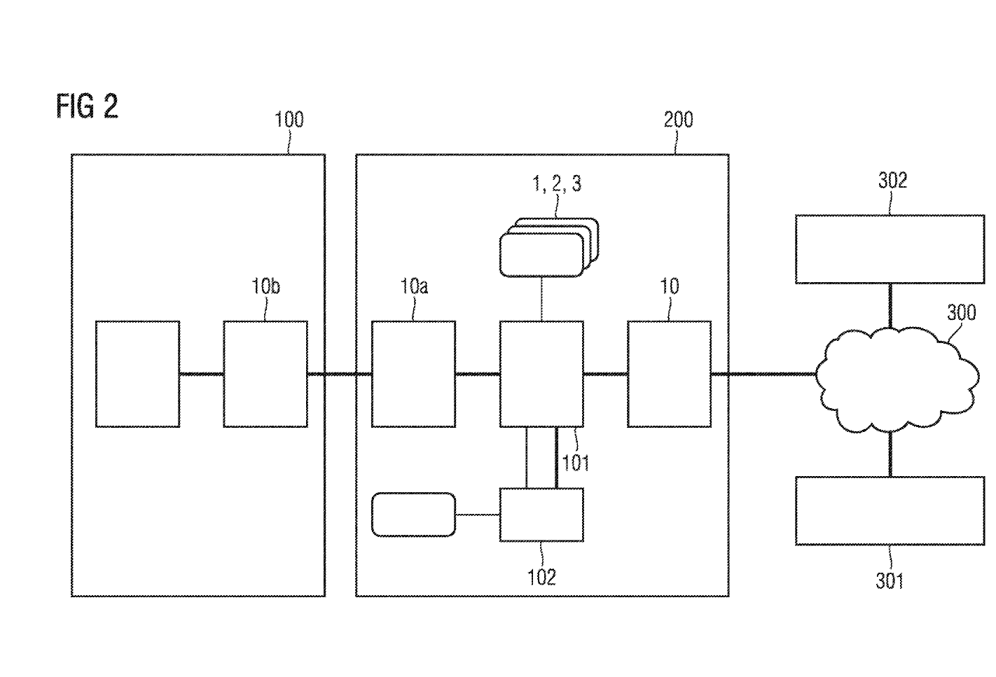

FIG. 2 shows a schematic depiction of an access device separately from a field device, according to a second embodiment of the invention; and

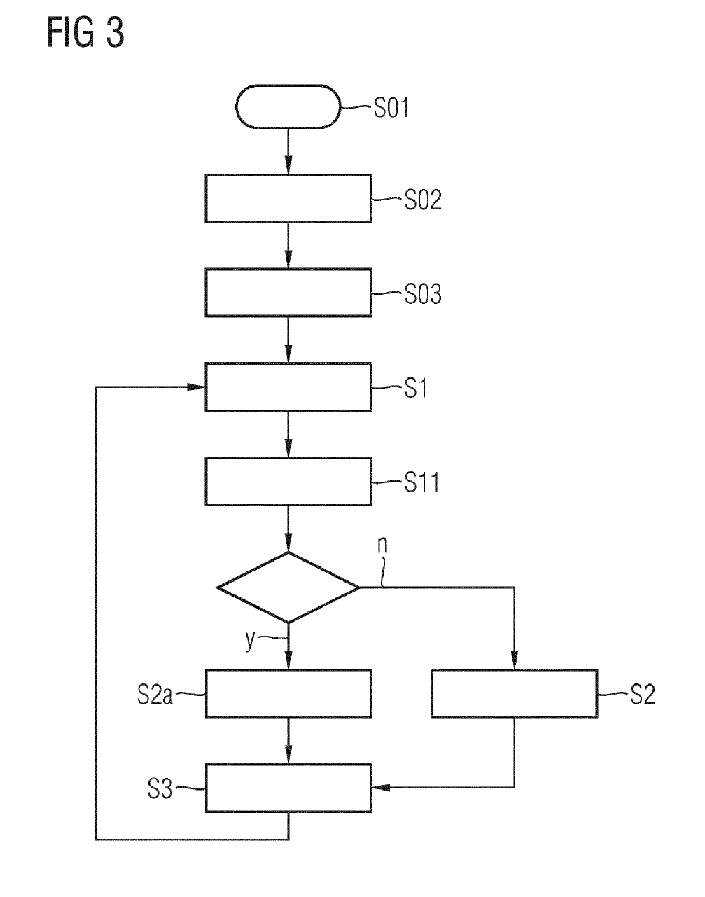

FIG. 3 shows a flow chart of a method for reducing a possibility of attack on a weak point of a device via a network access point, according to a further exemplary embodiment of the invention.

### DETAILED DESCRIPTION

Functionally identical elements in the figures are provided with the same reference signs unless stated otherwise.

FIG. 1 schematically depicts one implementation of embodiments of the invention according to a first exemplary embodiment of the invention in an Internet of Things or IoT environment. In this case, an IoT field device 100 is provided that has a drive controller as main function 103. The main function 103 communicates with a cloud service IoT data management platform 301 via the Internet. For example, data are requested from the cloud service by the field device, which data are processed for the purpose of optimizing the drive controller by way of the main function 103. The field device 100 authenticates itself with the network via a Network Access Control method, NAC for short, on the one hand, for example according to the 802.1X standard, and furthermore also authenticates itself with the cloud service, for example according to the Transport Layer Security protocol, TLS protocol, and a TLS client authentication or use of a digital device certificate. The communication between the field device 100 and the network 300 takes place via a network interface 10.

The field device 100, according to the first exemplary embodiment of the invention, has a network access filter 101 having several assigned filter policies 1, 2, 3 or filter rules. A component 102 for analyzing a configuration of the field device 100 is assigned to the network access filter 101. The analysis of the configuration in this case comprises for example testing the software configuration and firmware configuration. Up-to-dateness of the configuration is monitored in particular. As soon as it is detected that for example the most up to date update has not been installed, according to a selection policy 9 of the network access filter 101, activation of one of the filter rules 1, 2, 3 is configured. The selection policy 9 may in this case stipulate uniform filter rules to be activated for various analysis results. In particular, depending on the detected configuration state, a specific filter policy is proposed and activated by the selection policy 9.

In this implementation, an access device 200 is created that comprises the field device 100 and the network access filter 101, and therefore provides an integrated solution for restricting network connectivity by way of a field device itself. A client therefore itself detects a weak point in its own configuration and itself initiates a restriction of network access by way of corresponding filter policies. The filter policy is in this case applied topologically between the main function 103 of the device 100 and the network access point 10, that is to say on the client side. The functioning of the network remains unaffected, that is to say field devices do not have to be monitored on the server side and there also does not have to be any blocking of data connections or any filtering of data.

The second exemplary embodiment is explained schematically in FIG. 2. Unlike the first exemplary embodiment, the network access filter 101 is configured separately from the device 100 here. An access device 200 comprises the network access filter 101 and the component 102 for analyzing the configuration of the device 100. Both are provided externally to the field device 100. The network access point 10 to the network 300 is provided on the access device 200 in this example. The selected filter policy 1, 2, 3 is again applied between this network access point 10 and the main function 103 of the field device 100, that is to say on the client side.

The access device 200, in particular the component 102 for analyzing the configuration, may determine the current configuration state of the field device 100 in various ways. For example, a separate local interface, such as for example a service interface, in particular RS232, SPI, I2C or USB, is used. As an alternative, a network interface 10b of the field device 100, which network interface does not lead directly to the network 300 but rather initially to an interface 10a of the access device 200, may be used. For example, an OPC UA server or an HTTP/CoAP server or an SNMP server on the IoT field device 100 is used.

In another variant, communication of the field device 100 with an app manager or device manager 302 is monitored. A weak point is detected whenever it is not possible to establish communication of the field device with an app manager or device manager 302 for a given period of time. It is concluded indirectly from this that a configuration is not sufficiently up to date and possibly has weak points. After the field device 100 has contacted the app manager or device manager 302, it is concluded that the configuration is up to date and that there is therefore no weak point. Communication with standard restriction is consequently permitted, for example, in particular for a time interval that is able to be set. As an alternative, a current configuration of a field device may also be queried by a virtual twin or digital twin that is assigned to the field device 100.

A method for reducing a possibility of attack on a weak point of a device according to a further exemplary embodiment of the invention is described with reference to the flow chart in FIG. 3. The process is started in step S01. A filter policy that is applied by default for a phase in which the device is inspected for weak points is applied in step S02. This initial filter policy makes it possible just to test the up-to-dateness of a software configuration or firmware configuration. There is communication with the app/device manager of the Internet of Things network for this purpose. This takes place in step Si. Depending on the result of the analysis, which is determined in step S11, either a restricted filter policy is activated in step S2 in the event of a configuration n that is not up to date, or, in the event of a correct configuration y, a regular filter policy operation is activated in step S2a. During operation of a field device, the method may be performed repeatedly. The configuration is checked again S1 in particular after a first maintenance phase S3.

Although the invention has been illustrated and described in greater detail with reference to the preferred exemplary embodiment, the invention is not limited to the examples disclosed, and further variations can be inferred by a person skilled in the art, without departing from the scope of protection of the invention.

For the sake of clarity, it is to be understood that the use of “a” or “an” throughout this application does not exclude a plurality, and “comprising” does not exclude other steps or elements.

1. A method for reducing a possibility of attack on a weak point of a device via a network access point to a network,
analyzing in a first step, a configuration of the device,
detecting in a second step, in the event of a weak point on the basis of the analyzed configuration, in particular a lack of up-to-dateness of the configuration, communication via the network access point is restricted by way of a network access filter with the aid of a selectable filter policy, and
applying the filter policy topologically between the network access point and a main function of the device.

2. The method as claimed in claim 1, wherein the device authenticates itself with the network, via a Network Access Control method.

3. The method as claimed in claim 1, wherein the device authenticates itself with a cloud service, by way of a TLS method using a digital device certificate.

4. The method as claimed in claim 1, wherein the filter policy is able to be selected from a number of several filter policies.

5. The method as claimed in claim 4, wherein the network access filter activates one of the filter policies according to a fixed or changeable assignment policy.

6. The method as claimed in claim 1, wherein depending on the selected filter policy, further security rules of the device are furthermore adjusted.

7. An access device for protecting against an attack on a weak point of a device via a network access point to a network, comprising
a component for analyzing a configuration,
a network access filter for restricting communication via the network access point with the aid of a filter policy in the event of a weak point detected on the basis of the analyzed configuration,
wherein the network access filter is provided topologically between the network access point and a main function of the device.

8. The access device as claimed in claim 7, wherein the network access filter is integrated into the device.

9. The access device as claimed in claim 7, wherein the component is integrated into the device.

10. The access device as claimed in claim 7, wherein the network access filter is configured separately from the device.

11. The access device as claimed in claim 7, wherein the component is configured separately from the device.

12. The access device as claimed in 7, wherein the component has a local interface or a network interface to the device or a communication interface to a virtual twin of the device.

13. A computer program product, comprising a computer readable hardware storage device having computer readable program code stored therein, said program code executable by a processor of a computer system to implement a method having a computer program that has means for performing the method as claimed in claim 1 when the computer program is executed on a program-controlled apparatus.
